(19) United States
(12) Patent Application Publication
(10) Pub. No.: US 2016/0257553 A1
(43) Pub. Date: Sep. 8, 2016

(54) MODULAR BEVERAGE-DISPENSING SYSTEM

(71) Applicants: Esteban BANUS RICOMA, Las Palmas (ES); Fernando BANUS RICOMA, Las Palmas (ES)

(72) Inventors: Esteban BANUS RICOMA, Las Palmas (ES); Fernando BANUS RICOMA, Las Palmas (ES)

(21) Appl. No.: 15/032,057

(22) PCT Filed: Apr. 10, 2015
(86) PCT No.: PCT/ES2015/070283

§ 371 Date: Apr. 26, 2016

(30) Foreign Application Priority Data
May 20, 2014 (ES) P201430735

(51) Int. Cl. B67D 1/06; B67D 1/08; B67D 1/10

(52) U.S. Cl. CPC B67D 1/06; B67D 1/10; B67D 1/0888; B67D 1/0857; B67D 2001/0091

(57) ABSTRACT

The invention relates to a modular beverage-dispensing system, all of the elements thereof being modules, and comprising: a storage module which, in turn, comprises a container-like storage body for liquid containers, the storage module having at least one nozzle that can be connected to each liquid container; a pump module comprising a pump body which, in turn, houses pump means communicating, by means of fluid, with each of the nozzles arranged on the storage module; and a control module comprising a beverage-dispensing device communicating, by means of fluid, with the pump means, and control means communicating, by means of data, with the pump module, wherein the storage body, the pump body and the dispensing device comprise detachably interconnectable joining means.

### OBJECT OF THE INVENTION

The object of the present application is to register a modular beverage-dispensing system which incorporates notable innovations.

More specifically, the invention proposes the development of a modular beverage-dispensing system, all of the elements of which are modular, allowing the system to be installed by positioning each one of the elements independently or as a compact unit.

### BACKGROUND OF THE INVENTION

Automatic systems for dispensing beverages are known, which comprise units with all the components incorporated. These systems are unitary machines which comprise the distribution, the pumping and the storage, it possibly being the case where the barrels, where the beverages to be distributed are stored, are separated at a relatively small distance from the rest of the components.

However, these known systems have a module that is already configured which complicates the installation at different points of sale since these systems have to be adapted for each client and the space required. This entails deficient fitting of the dispensing system.

Furthermore, a configuration such as a compact unit requires various operators for transferring and installing the dispensing device.

### DESCRIPTION OF THE INVENTION

The present invention has been developed with the aim of providing a modular beverage-dispensing system which resolves the previously mentioned drawbacks, also providing other additional advantages which will be evident from the description which is included below.

The object of the present invention is a modular beverage-dispensing system which comprises:

a storage module which, in turn, comprises a container-like storage body, wherein the storage body is adapted for housing at least one liquid container, the storage module having at least one nozzle that can be connected to each liquid container;

a pump module which comprises a pump body which, in turn, houses pump means communicating, by means of fluid, with each of the nozzles arranged on the storage module;

a control module which comprises at least one beverage-dispensing device communicating, by means of fluid, with the pump means and control means communicating, by means of data, with the pump module,

wherein the storage body, the pump body and the dispensing device respectively have detachably interconnectable joining means.

It should be indicated that in the present description, the term “nozzle” is understood as an embodiment of an inlet/outlet port of the liquid. In addition, the term “beverage” should be understood as any potable liquid such as spirituous, flavored or energy beverages, juices, wines, sodas, beer, milk, water, mixed beverages or cocktails as well as the combinations of the same.

Owing to these characteristics, a modular system is achieved which allows each one of the components to be positioned independently or as a compact unit, enabling it to be installed in different configurations. This facilitates the installation at any point of sale since the present modular system allows an optimal adaptation to the type of client and to the space available. Furthermore, the configuration of this modular system allows the entire machine to be capable of being transferred and installed by one single operator, something which is not possible with the compact units of the state of the art.

In a preferred embodiment, the joining means may comprise connectors for liquid pipes arranged in the storage body, the pump body and the dispensing device; in addition, a plurality of liquid tubes that are respectively connectable to the connector can also be provided. These tubes can be used when some of the different modules are distributed independently. The joining means can further comprise a plurality of fixing elements.

In order to facilitate the manipulation and transport, at least one of the storage body, the pump body and the dispensing device comprise roller means.

In addition, the storage body, the pump body and the dispensing body can have exterior coverings.

The storage module can further comprise a chiller unit which allows the liquid containers to be cooled; a basket for carrying the liquid container, a drip tray, an identifier device capable of receiving information from each liquid container, said identifier device communicating, by means of data, with the control means.

Preferably, the pump means comprise at least one liquid pump.

The control module may further comprise guide means by means of light emission, a receptacle cleaning device. In terms of the control means, they can advantageously comprise a control unit connected to a user interface.

Other characteristics and advantages of the modular beverage-dispensing system object of the present invention will be evident from the description of a preferred, but not exclusive embodiment, which is illustrated by way of non-limiting example in the drawings which are included, in which:

### BRIEF DESCRIPTION OF THE DRAWINGS

FIG. 1 is a perspective view of the three modules of the modular system of the present invention; and

FIG. 2 is an exploded view of the three modules of FIG. 1;

FIGS. 3-6 are perspective views of four possible configurations of the modular system wherein the modules are positioned separately; and

FIGS. 7-10 are perspective views of four possible configurations of the modular system wherein the modules are positioned as a unit.

### DESCRIPTION OF A PREFERRED EMBODIMENT

As is shown in the attached figures, a preferred, but not exclusive embodiment of a modular beverage-dispensing system according to the present invention is depicted.

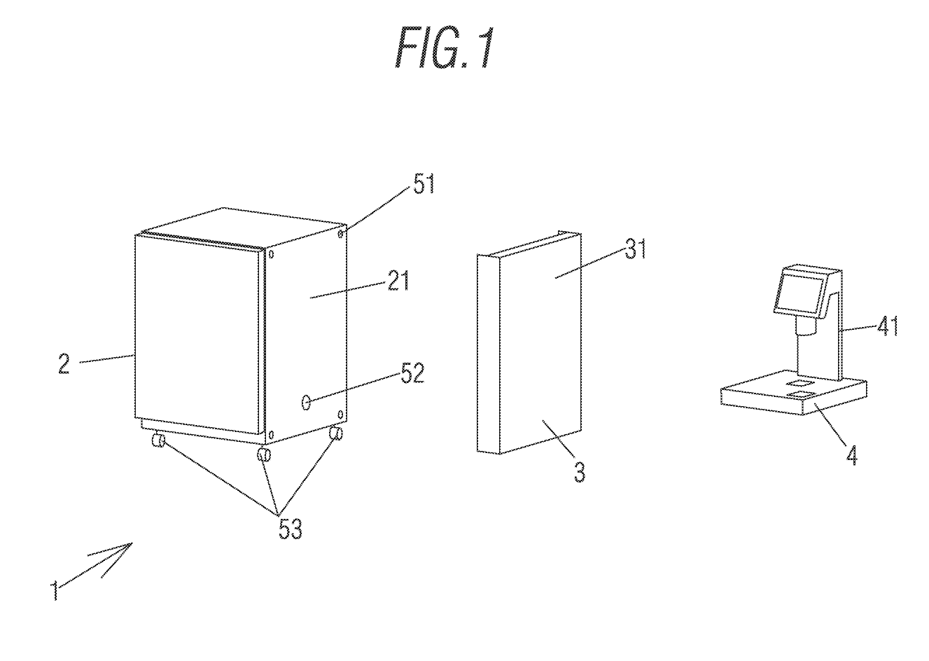

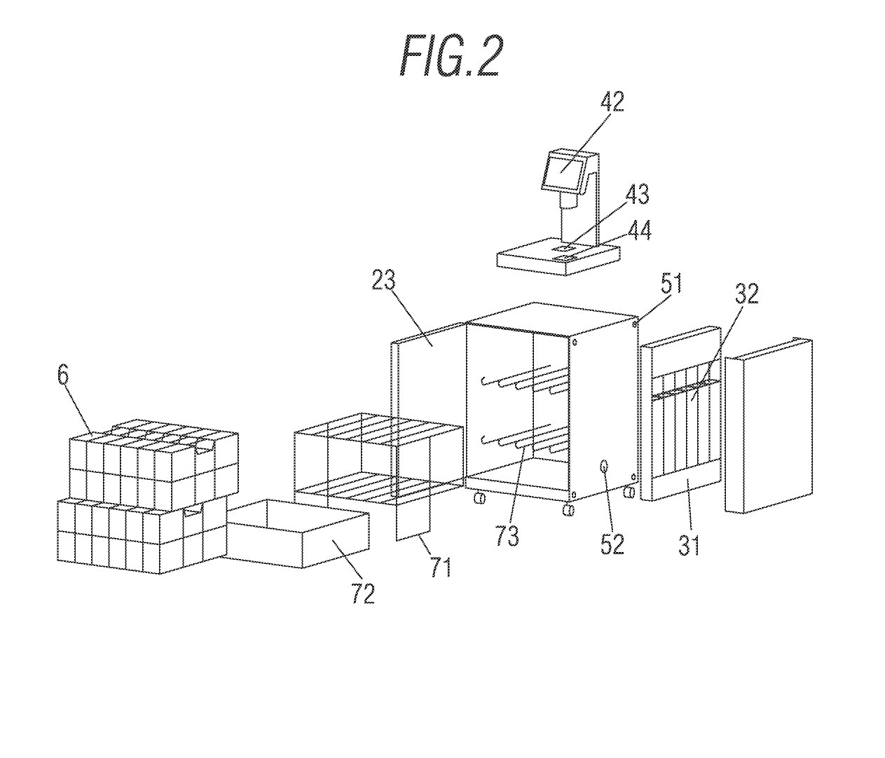

In FIGS. 1 and 2, a modular beverage-dispensing system 1 is illustrated which comprises: a storage module 2 which, in turn, comprises a container-like storage body 21, wherein the storage body 21 is adapted for receiving and housing at least one liquid container 6, the storage module 2 having at least one nozzle (not depicted) that can be connected to each liquid container 6. The storage body 21 is provided with a cover or door 23 which allows access to the interior of the same, in this interior, the required liquid containers 6 can be housed. These liquid containers 6 are preferably arranged in a carrier basket 71 and advantageously the configuration of the carrier basket 71 will be such that it allows the liquid containers 6 to be housed in said carrier basket 71. This carrier basket 71, in turn, can be fixed on the interior of the storage body 21 owing to support hooks 73 or any other support means. In FIG. 2, it can be seen that the storage body 21 further comprises a drip tray 72 for receiving any drops or residue coming from the liquid containers 6. Furthermore, the storage module 2 can comprise a chiller unit (not depicted) which allows the liquids contained in the liquid containers 6 inside the storage body 21 to be kept cool. More detail on the chiller unit will not be provided since it can be any chiller unit within the scope of the person skilled in the art.

The present system further comprises a pump module 3 which, in turn, comprises a pump body 31 which houses pump means communicating, by means of fluid, with each one of the nozzles arranged on the storage module 2. The pump means comprise at least one liquid pump 32, in this particular embodiment there are various liquid pumps 32. This pump module 3 can preferably be installed adjacent to the storage module 2.

Another module present in the invention is a control module 4 which comprises at least one beverage-dispensing device 41 communicating, by means of fluid, with the pump means and control means communicating, by means of data, with the pump module 3, the control means comprise a control unit (not depicted) connected to a user interface 42 such as for example a touch screen. The control module 4 advantageously comprises guide means 43 by means of light emission. These guide means 43 allows the user to correctly position a receptacle for receiving the beverage by means of an indicative light beam; furthermore the user can regulate the height of the dispensing device 41 to adapt it to different situations. Another element which may be advantageously present on the control module 4 is a receptacle cleaning device 44. This cleaning device 44 can be of any known type, such as for example one that produces a cleaning water jet on the receptacle where the beverage will be dispensed.

In addition, the control module 4 can comprise a self-cleaning device (not depicted) of the dispenser and the pipes of said control module 4. Greater detail on this self-cleaning device will not be provided since it can be any self-cleaning device that is available on the market.

Advantageously, the storage body 21, the pump body 31 and the dispensing device respectively have detachably interconnectable joining means. The joining means comprise connectors 52 for liquid tubes arranged on the storage body 21, the pump body 31 and the dispensing device 41, in addition, the joining means further comprise a plurality of fixing elements 51.

Advantageously, the modular beverage-dispensing system 1 can comprise a plurality of liquid tubes that are respectively connectable to the connectors 52. These tubes are not depicted in the attached figures for greater clarity and understanding of the invention and are used when the different modules are not positioned adjacent to each other and therefore it is necessary to interconnect them by means of fluid.

In order to facilitate the manipulation and transport of the different modules, at least one of the storage body 21, the pump body 31 and the dispensing device 41 comprise roller means 53. In the attached figures, said roller means 53 have been provided on the base of the storage body 21.

It is envisaged that the storage module 21 can comprise an identifier device (not depicted) capable of receiving information from the liquid containers 6. It can be an identifier device available in the state of the art, said identifier device communicating, by means of data, with the control means. In this way, the control means can verify the type of liquid contained in the liquid containers 6. The data communication may be, for example by cable or wirelessly.

Once installed, the storage body 21, the pump body 31 and the dispensing device 41 can have exterior coverings 7 for configuring a unit module.

When the user wishes to dispense a beverage (single or combined), they input their selection by way of the user interface 42. This, in turn, transmits the selection to the control means which, in turn, transmits the corresponding command to the pumps 32. Of these pumps 32, only the pump or pumps related to the liquid containers 6 required in order to obtain the desired beverage begin to operate. When each pump 32 is communicating, by means of fluid, with each liquid container 6, the liquid contained in the liquid container 6 leaves the same through the nozzle, it continues through liquid pipes arranged on the interior of the storage body 21 and from there leaves towards the pump body 31. If the storage body 21 is separated from the pump body 31, a tube can be provided between both bodies which connects the connectors 52 correspondingly arranged in the storage body 21 and the pump body 31. From the pump 32, the liquid continues through the liquid pipes arranged on the interior of the pump body 31. Similar to the connection between the storage body 21 and the pump body 31, the pump body 31 is connected to the dispensing body 41, with the corresponding connectors 52 thereof and possible tubes between them.

At the same time the user has correctly positioned a receptacle for receiving the beverage owing to an indicative light beam emitted by the guide means 43. The receiving receptacle in the cleaning device 44 may previously be cleaned. Lastly, the beverage selected by the user is dispensed inside the receiving receptacle.

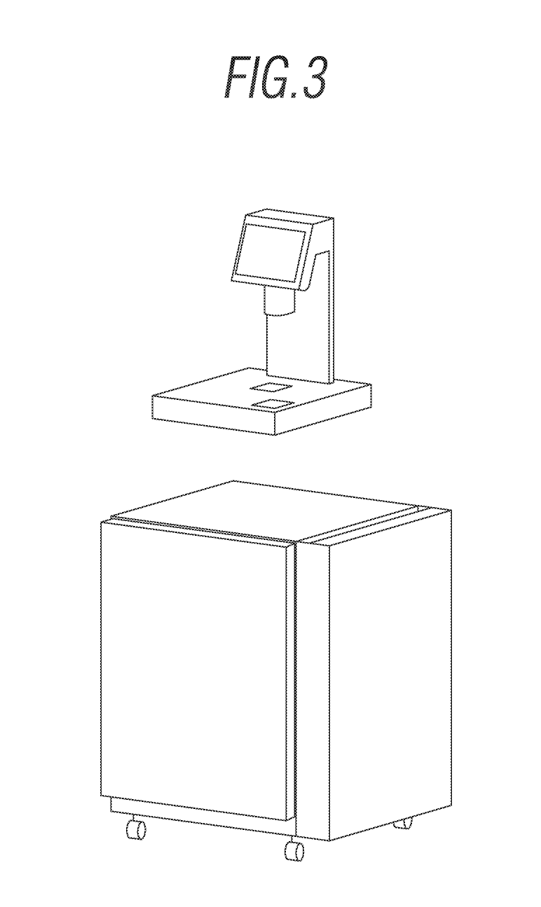

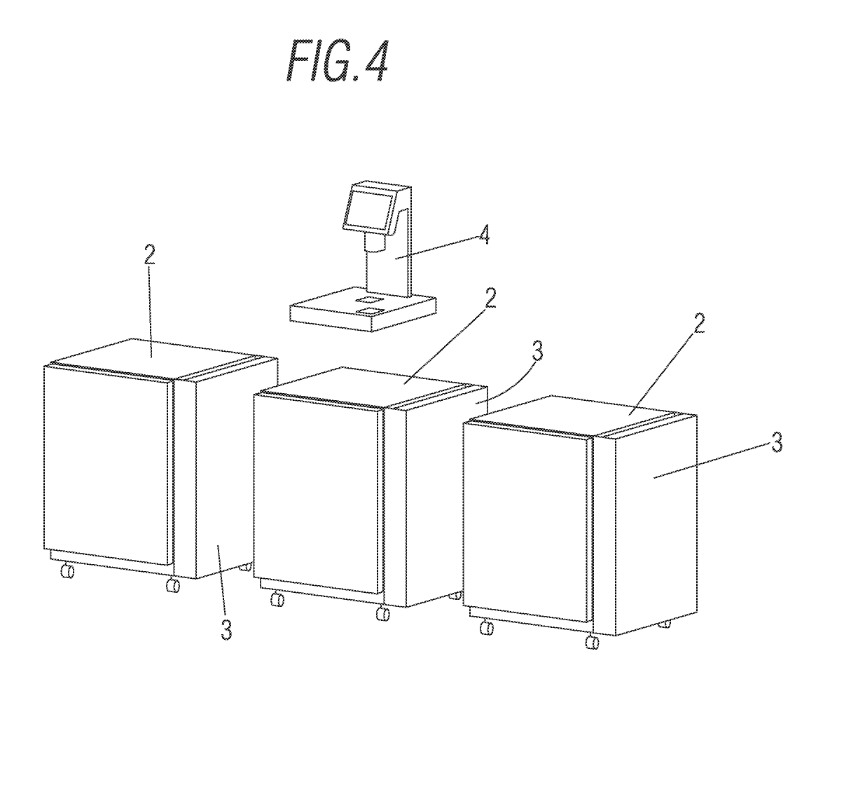

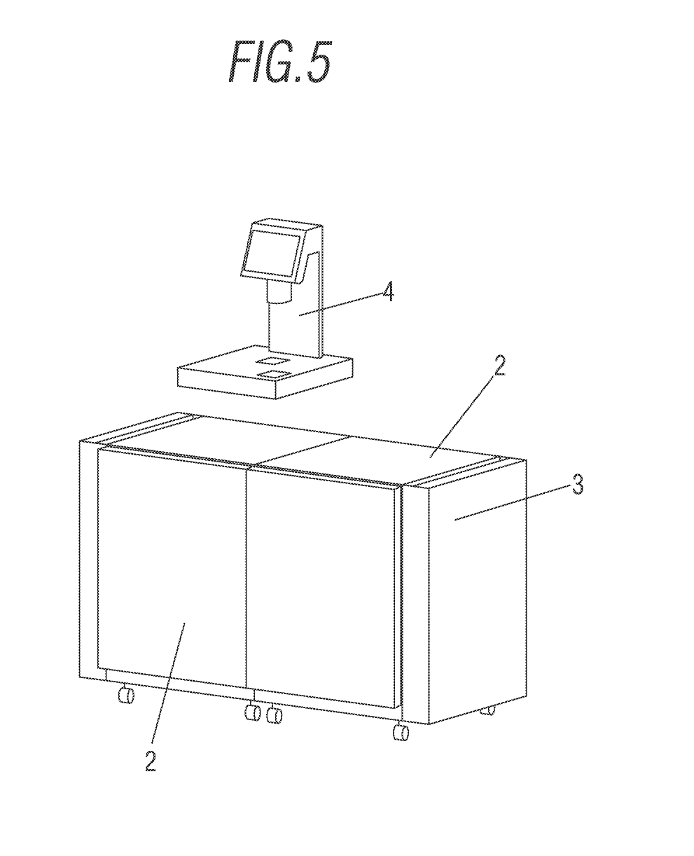

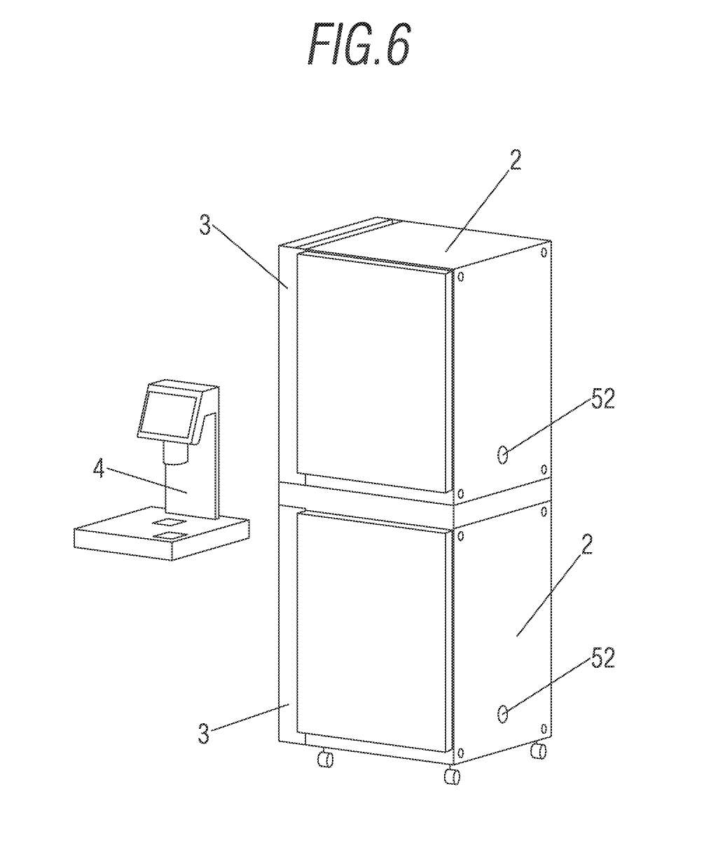

In FIGS. 3-6, different possible combinations of the three modules of the present invention can be observed in one installation wherein at least one of these is positioned independently although obviously interconnected to the rest of the modules by means of fluid and with data exchange. The dispensing device 41 can be positioned depending on the particular requirements of the installation and in addition the quantity of the other modules can be varied if, for example it is necessary to store a large quantity or variety of liquids in the storage module 2. The storage bodies 21 have roller means 53 thereof to facilitate the transport and distribution of the same in the installation. It should be mentioned that in spite of the fact that no pipes have been illustrated between the different modules, the person skilled in the art understands that they are necessary for the correct functioning of the installation.

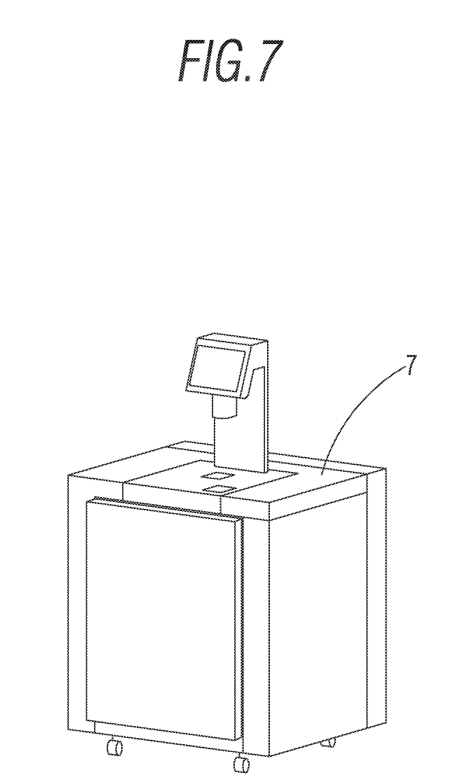

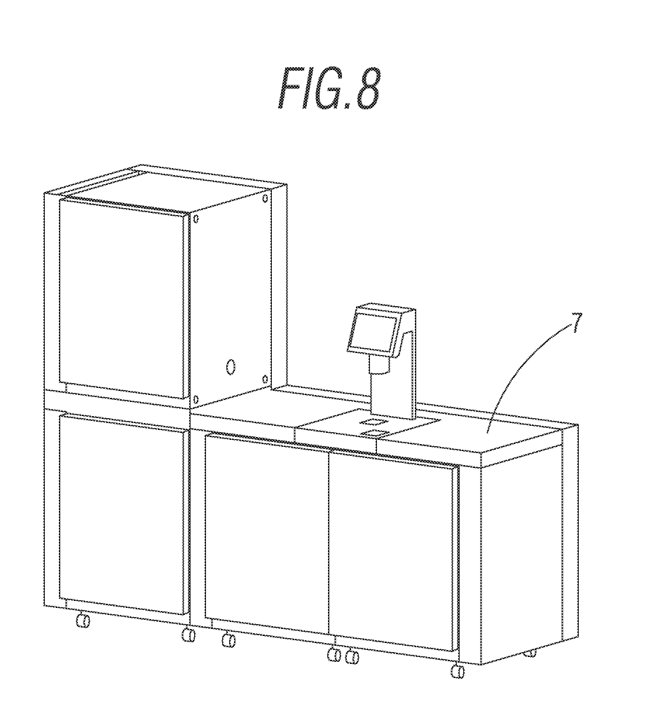

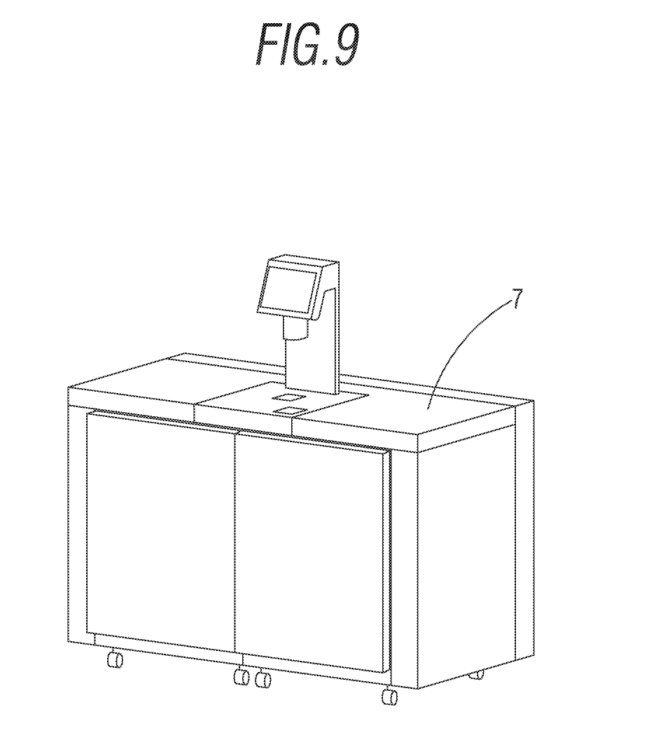

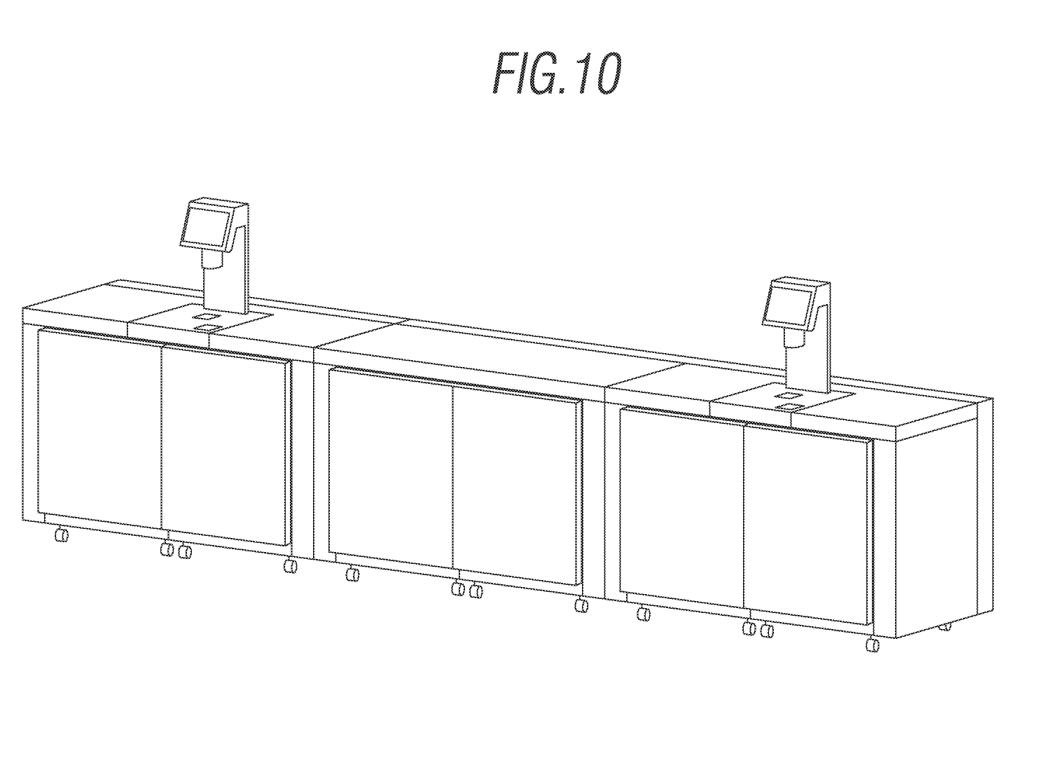

In addition, in FIGS. 7-10, different possible combinations of the three modules of the present invention are illustrated in one installation wherein they are positioned as a unit, even stacked in a column. The quantity of the different modules that is required and a series of exterior coverings 7 can be used for suitably configuring the installation. The fixing of the different exterior coverings 7 may be implemented by any suitable means. In this case, the connectors 52 can be directly connected to each other, for example a connector 52 situated on the walls of the storage body 21 with another connector 52 correspondingly situated on the walls of the pump body 31.

Of course the different modules are fixed to each other with a plurality of fixing elements 51 when they are positioned adjacent to each other.

When it is necessary to replenish or replace the liquid containers 6, the person skilled in the art opens the cover or door 52 and proceeds to remove the liquid container 6 from the position thereof in the basket, disconnecting the nozzle and reintroducing it into the liquid container 6.

The details, the forms, the dimensions and other accessory elements as well as the materials used in the manufacture of the modular beverage-dispensing system of the invention can be conveniently substituted for others which do not depart from the scope defined by the claims which are included below.

1. A modular beverage-dispensing system (1) characterized by the fact that it comprises:
a storage module (2) which, in turn, comprises a container-like storage body (21), wherein the storage body (21) is adapted for housing at least one liquid container (6), the storage module (2) having at least one nozzle that can be connected to each liquid container (6);
a pump module (3) which comprises a pump body (31) which, in turn, houses pump means communicating, by means of fluid, with each of the nozzles arranged on the storage module (2);
a control module (4) which comprises at least one beverage-dispensing device (41) communicating, by means of fluid, with the pump means and control means communicating, by means of data, with the pump module (3),
wherein the storage body (21), the pump body (31) and the dispensing device (41) respectively have detachably interconnectable joining means.

2. The modular beverage-dispensing system (1) according to claim 1, wherein the joining means comprise connectors (52) for liquid pipes arranged on the storage body (21), the pump body (31) and the dispensing device (41).

3. The modular beverage-dispensing system (1) according to claim 2, wherein it further comprises a plurality of liquid tubes respectively connectable to the connectors (52).

4. The modular beverage-dispensing system (1) according to claim 2, wherein the joining means further comprise a plurality of fixing elements (51).

5. The modular beverage-dispensing system (1) according to claim 1, wherein at least one of the storage body (21), the pump body (31) and the dispensing device (41) comprise roller means (53).

6. The modular beverage-dispensing system (1) according to claim 1, wherein the storage module (2) further comprises an identifier device capable of receiving information from the liquid container (6), said identifier device communicating, by means of data, with the control means.

7. The modular beverage-dispensing system (1) according to claim 1, wherein the storage body (21), the pump body (31) and the dispensing device (41) have exterior coverings (7).

8. The modular beverage-dispensing system (1) according to claim 1, wherein the storage module (2) further comprises a chiller unit.

9. The modular beverage-dispensing system (1) according to claim 1, wherein the storage module (2) further comprises a basket (71) for carrying the liquid container (6).

10. The modular beverage-dispensing system (1) according to claim 1, wherein the storage module (2) further comprises a drip tray (72).

11. The modular beverage-dispensing system (1) according to claim 1, wherein the pump means comprise at least one liquid pump (32).

12. The modular beverage-dispensing system (1) according to claim 1, wherein the control means comprise a control unit connected to a user interface (42).

13. The modular beverage-dispensing system (1) according to claim 1, wherein the control module (4) further comprises guide means (43) by means of light emission.

14. The modular beverage-dispensing system (1) according to claim 1, wherein the control module (4) further comprises a receptacle cleaning device (44).
